(19) United States
(12) Patent Application Publication
(10) Pub. No.: US 2017/0321728 A1
(43) Pub. Date: Nov. 9, 2017

(54) Pressure Intensifier for Fluids

(71) Applicant: Scanwill Fluid Power ApS, Albertslund (DK)

(72) Inventor: Jesper Will Iversen, Albertslund (DK)

(21) Appl. No.: 15/581,543

(22) Filed: Apr. 28, 2017

(30) Foreign Application Priority Data
May 4, 2016 (EP) 16168387.5

(51) Int. Cl. F15B 3/00

(52) U.S. Cl. CPC F15B 3/00

(57) ABSTRACT

A pressure intensifier for fluids, in particular for liquids, comprising a cylinder block in which a pressure intensifier piston and a control piston move cyclically, wherein the pressure intensifier piston forms a high-pressure working chamber and a low-pressure working chamber in the cylinder block and the cylinder block has a low-pressure connection for feeding in low-pressure fluid from outside, a high-pressure connection for discharging higher-pressure working fluid towards the outside and a connection for discharging fluid whose working capacity in the pressure intensifier is exhausted, wherein the cylinder block has a coupling portion rigidly connected with it, which can be inserted into a receiving bore of a hydraulic block and fixed there, so that the receiving bore encloses the coupling portion, wherein the coupling portion has at least two fluid transfer regions fluidically separated by a seal, for exchanging fluid between the pressure intensifier and the hydraulic block into which it is inserted.

### CROSS REFERENCE APPLICATIONS

This application is a non-provisional application claiming priority from European application no. 16168387.5 filed May 4, 2016 which is hereby incorporated by reference for all purposes.

### SUBJECT MATTER OF THE DISCLOSURE

The disclosure relates to a preferably hydraulic pressure intensifier according to the preamble of claim 1.

Herein, the term pressure intensifier refers to a device that automatically, without an additional external drive, produces from a drive fluid that is available with a low pressure a working fluid discharged by it under a higher pressure. The details of such a device are explained in more detail later.

### BACKGROUND TECHNOLOGY

Pressure intensifiers of this kind are used in many areas. The following list of areas of application is not exhaustive. For example, such pressure intensifiers are used for producing a high-pressure water jet for a cleaning device by means of a low-pressure vehicle hydraulic system or for operating rescue shears with high pressure for rescuing passengers from vehicles involved in an accident. Such pressure intensifiers are used in a variety of forms also in industrial application, for example, in order to provide chucking tools of rotating chucks with the high pressure required for chucking. The chucking tools may be chucking tools used in industrial production or chucking tools used in assembly, and the rotating chucks can be components of a machine tool or, for example, of a drill rod assembly for carrying out ground drilling.

The pressure intensifiers can be used separately or connected in series in a cascading manner if a particularly high pressure, which cannot be achieved by means of a single pressure intensifier, is to be generated.

The pressure intensifiers known in the prior art are typically connected via high-pressure hoses or hydraulic tubes to the hydraulic block that supplies them with hydraulic fluid under low pressure and receives used-up hydraulic fluid. The connection to the high-pressure consumer, which is supplied with the hydraulic fluid under increased pressure generated by the pressure intensifier, is generally carried out via hydraulic hoses or tubes.

The connection of a pressure intensifier using high-pressure hoses or tubes to the hydraulic system supplying it, and optionally also to the consumer supplied by it, is problematic. On the one hand, this is due to the fact that hydraulic hoses may age over time and then tend to leak. Hydraulic tubes may fatigue over time, particularly because they are to an oscillating stress. The connection with hydraulic hoses and tubes is also problematic where several pressure intensifiers are used, possibly because they are connected in series in a cascading manner. This rather quickly results in problems as regards space, and in the end, the installation cannot be kept as compact as would be desirable in actual fact. The use of hydraulic hoses in rotating systems, where the pressure intensifier co-rotates, is particularly problematic.

The idea of directly flange-mounting a pressure intensifier to a hydraulic block, so that the outer surfaces of the pressure intensifier and of the hydraulic block are pressed tightly against each other in a plane and fluid can be transferred without a hose, is critical. Flanges of this type require considerable construction space in the transverse direction, a lot of effort with regard to the screw connections, and give rise to sealing issues at high pressures.

Therefore, the disclosure is based on the aspect of providing a pressure intensifier that can be connected to a hydraulic block without tubes and hoses and at the same time particularly reliably. This aspect is accomplished with the features of claim 1.

### SUMMARY

What is claimed is a pressure intensifier for fluids, in particular for liquids—which is generally operational and only requires the connection to a pressure supply, a tank connection and a consumer for the higher pressure generated by it. Thus, the pressure intensifier forms an operational unit for complete or partial insertion into a hydraulic block.

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

The pressure intensifier consists of a cylinder block in which a pressure intensifier piston and a control piston move cyclically. The control piston is able to assume different positions and thereby determines the work cycles of the pressure intensifier piston, wherein the control piston is not actuated by a mechanical forced control in the manner of a camshaft, but purely by differential pressure. The pressure intensifier itself is configured in such a way that whenever it has reached a certain position, it initiates a change of the pressure conditions on the control piston so that the latter changes its position.

The pressure intensifier piston is preferably configured as a differential piston with two hydraulically operative piston surfaces of different sizes; in any case, it forms a high-pressure working chamber and a low-pressure working chamber in the cylinder block. Generally, the pressure intensifier piston is massive, i.e. is preferably has no through-bores which, for example, connect the high-pressure working chamber and the low-pressure working chamber. Instead, the pressure intensifier piston generally has a constricted portion in the area of its circumference, which forms an intermediate space that is located between the high-pressure working chamber and the low-pressure working chamber.

The cylinder block has an external connection for feeding in pressurized fluid from outside, which is also referred to as a low-pressure connection—because the pressure of the fluid present here is lower than the pressure of the fluid discharged by the pressure intensifier to the consumer.

The fluid under said low pressure is intended for carrying out work in the pressure intensifier, and optionally also serves as a base for generating and outputting high-pressure fluid, i.e. fluid under a higher pressure than the low-pressure fluid. In any case, the high-pressure fluid is discharged towards the outside to an external consumer via an external high-pressure connection as a working fluid that is under a higher pressure.

Finally, the pressure intensifier has a connection for discharging fluid whose working capacity in the pressure intensifier is exhausted. This connection is hereinafter also referred to as a tank connection, even if it need not lead to a tank in the strict sense of the word. It should also be noted that said intermediate space is generally a part of a channel leading to the tank connection.

Here, a cylinder block of the pressure intensifier is preferably understood to be a massive metallic body that contains all the cylinder bores and channels required for the cooperation of the pressure intensifier piston and the control piston. In the predominant number of cases, the massive metallic body has, in the area of the control piston and of the pressure intensifier piston in any case, cross sections everywhere in which the surface area that the solid material takes up in cross section is greater than the surface area that the cylinder bores and the channels take up in cross section.

The cylinder block of the pressure intensifier has a coupling portion connected to it rigidly. The coupling portion is configured in such a way that it can be inserted into a receiving bore of a hydraulic block. In this case, it is configured in such a way that the receiving bore encloses the coupling portion at its circumference and generally also at its end face. In this case, the coupling portion has at least two fluid transfer regions fluidically separated by a seal, which serve for exchanging fluid between the pressure intensifier and the hydraulic block into which it is inserted.

The fluid transfer regions are positioned in such a way on the coupling portion that they are located in the interior of the hydraulic block into which the coupling portion has been inserted, underneath the outer surface of the hydraulic block against which the part of the pressure intensifier rests that has not been inserted into the hydraulic block. Generally, the fluid transfer regions are located at least 20 mm, better at least 30 mm underneath the surface of the hydraulic block.

Thus, a particularly compact and reliable fluidic connection is produced between the pressure intensifier and the hydraulic block of the machine that the pressure intensifier supplies. Due to the fact that the fluid transfer regions are far inside the hydraulic block and are thus disposed in a particularly rigid region, a reliable seal can easily be obtained even under high pressure—even if disruptive factors, such as vibrations, are added.

Preferably, the pressure intensifier is configured in such a way that, coming from inside the cylinder block of the pressure intensifier, a channel, via which the pressure intensifier discharges fluid in operation whose working capacity that can be used within the pressure intensifier is exhausted, leads into a fluid transfer region. In this case, another channel, also coming from inside the cylinder block, leads into another fluid transfer region. Low-pressure fluid is fed into the pressure intensifier via this channel, i.e. fluid that drives the pressure intensifier and optionally also forms the basis for generating higher-pressure fluid to be discharged to a consumer.

Ideally, the coupling portion has a third fluid transfer region for transferring the higher-pressure working fluid to the hydraulic block. In this case, no tubes or hydraulic hoses are required to connect the pressure booster with its surroundings and thus render it operational. Instead, a direct hydraulic connection between the cylinder block of the pressure booster and the hydraulic block is carried out.

Ideally, at least one of the fluid transfer regions has a peripheral annular groove in the circumferential shell surface of the coupling portion. It is thus ensured that the corresponding fluid transfer region is securely connected to the corresponding bore in the hydraulic block, irrespective of whether the coupling portion of the pressure booster has been pushed more or slightly less deeply into the hydraulic block, or which rotary position the coupling portion assumes therein.

Generally, the coupling portion has a male thread for screwing the coupling portion into the hydraulic block. In this way, the coupling portion is anchored in the hydraulic block in a mechanically secure manner.

The several fluid transfer regions are in this case preferably disposed between the free end of the coupling portion to be inserted into the hydraulic block and the male thread of the coupling portion. The outer diameter of the coupling portion tapers mostly at the transition between the male thread and the rest of the coupling portion. Typically, the cylinder block of the pressure intensifier has a molded-on hexagon for applying a screwing tool.

Preferably, at least two bores extending parallel to the longitudinal axis of the pressure intensifier run through coupling portion, which extend from the free end face of the coupling portion into the area of the cylinder block of the pressure intensifier, which is always positioned outside the hydraulic block accommodating the coupling portion.

With such bores in the coupling portion that extend parallel to the longitudinal axis of the pressure intensifier, the required fluidic connection between the corresponding channels inside the cylinder block of the pressure intensifier and the fluid transfer regions can be easily produced. The bores can be introduced in a single working step from the end face of the coupling portion until they intersect with the channels inside the pressure intensifier that are to be connected by them. In particular, such bores make it very easy to form one of the fluid transfer regions at the free end face of the coupling portion and the other of the fluid transfer regions in the area of the circumferential shell surface of the coupling portion.

Independent protection is sought for a hydraulic unit with a hydraulic block in which several bores, through which hydraulic fluid flows, for connecting different hydraulic operative units (controllable or non-controllable valves and/or pumps and/or pressure compensation vessels and/or several pressure intensifiers) are formed, and that comprises at least one pressure intensifier of the type of the disclosure, wherein the pressure intensifier has a coupling portion inserted into a bore in the hydraulic block and fixed therein.

It is particularly beneficial if at least two, better three, pressure intensifiers are connected in series one behind the other at the hydraulic unit, so that the high pressure provided by a pressure intensifier preceding in the (high-pressure) flow direction constitutes the pressure with which a subsequent pressure intensifier in the flow direction is supplied on the input side. In this way, particularly high pressures can be generated in a cascading manner. In this case, the hydraulic unit can be configured to be particularly compact because the pressure intensifiers require no tube system or hydraulic hoses for connection with the hydraulic block and can thus be fitted to the hydraulic block in a very densely packed manner.

In addition to the exemplary aspects and embodiments described above, further aspects and embodiments will become apparent by reference to the accompanying drawings forming a part of this specification wherein like reference characters designate corresponding parts in the several views.

### LIST OF FIGURES

FIG. 1 shows the hydraulic circuit diagram wound off into a single plane and the conditions during a work cycle of the pressure intensifier piston.

FIG. 2 shows the same hydraulic circuit diagram wound off into a single plane and the conditions at a time at which the pressure intensifier piston has reached its upper dead center after a work cycle.

FIG. 3 shows the same hydraulic circuit diagram wound off into a single plane and the conditions during a charging cycle of the pressure intensifier piston.

Based on FIG. 1, FIG. 4 shows the conditions during normal operation in which fluid which is discharged under high pressure is generated using an external switching valve provided with a corresponding circuit.

Based on FIG. 1, FIG. 5 shows the conditions during a switching operation in which the high-pressure consumer is switched to be pressureless or even emptied in a reverse direction via the pressure intensifier, using an external switching valve provided with a corresponding circuit.

FIG. 6 shows a first physically specific exemplary embodiment of the pressure intensifier according to the disclosure.

FIG. 7 shows the coupling portion of the pressure intensifier as a detail from FIG. 6.

FIG. 8 shows a second physically specific exemplary embodiment of the pressure intensifier according to the disclosure.

FIG. 9 shows the pressure intensifier according to FIG. 8 in an enlarged half-section.

FIG. 10 shows the exemplary embodiment according to FIGS. 6 and 7 in a state removed from the hydraulic block, shown in perspective.

FIG. 11 shows the exemplary embodiment according to FIGS. 6 and 7 in a state removed from the hydraulic block, shown in a side view.

FIG. 12 shows the exemplary embodiment according to FIGS. 8 and 9 in a state removed from the hydraulic block, shown in perspective.

FIG. 13 shows the exemplary embodiment according to FIGS. 8 and 9 in a state removed from the hydraulic block, shown in a side view.

Before explaining the disclosed embodiment of the present disclosure in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

First, the basic workings of the pressure intensifier according to the disclosure must be explained, which is characterized by its particularly simple design and is therefore eminently suitable for providing a pressure intensifier with a particularly compact construction, so that the pressure intensifiers operating in accordance with this principle are eminently suitable for being equipped with the connection that constitutes the core of the disclosure.

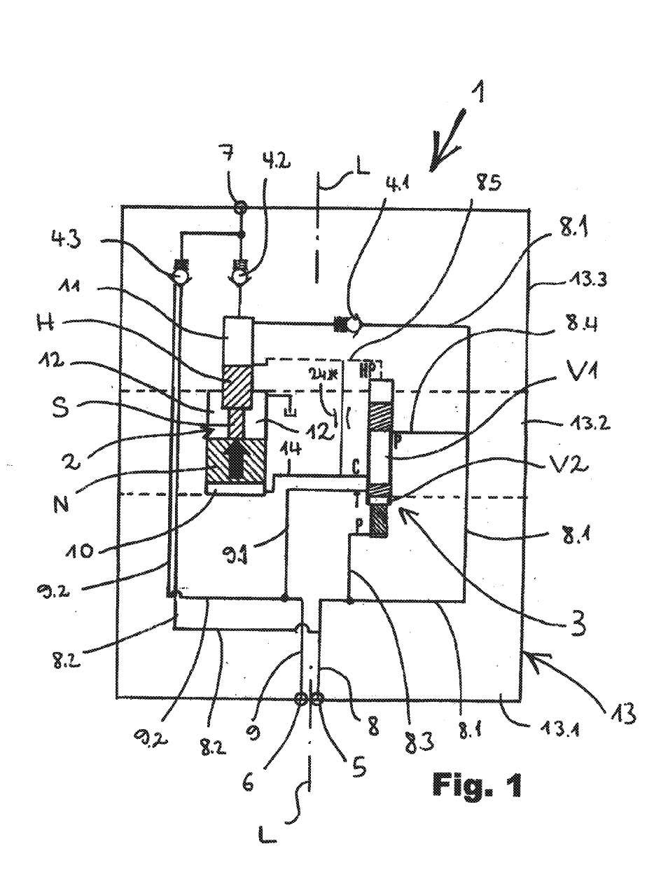

In this regard, reference is made to FIG. 1.

FIG. 1 shows the pressure intensifier 1 which is formed in its entirety in a metallic, preferably steel, cylinder block 13, which is represented in cross section in this case, and therefore only schematically as a box-like contour by four solid lines forming a rectangle. The cylinder block preferably has the outer contour of a cylinder that is rotationally symmetric about the longitudinal axis L. The cylinder block 13 consists of at least two and ideally three separate, i.e. mutually detachable, cylinder block members that are not connected with each other by any material. In the preferred embodiment shown specifically by FIG. 1, the cylinder block 13 consists of three cylinder block members 13.1, 13.2 and 13.3, as is indicated by the dashed dividing lines. The several cylinder block members are positively fixed relative to one another in a defined position, for example using locating pins not shown in the drawing.

A pressure intensifier piston 2 works in this cylinder block. This pressure intensifier piston 2 is typically configured as a differential piston with two differently sized hydraulic operating areas that are force-effective in opposite directions, and then consists of a low-pressure piston N with a large diameter and a high-pressure piston H with a small diameter that are firmly connected to each other by a piston shaft S. The low-pressure piston N forms a low-pressure working chamber 10 in the cylinder block, whereas the high-pressure piston H forms a high-pressure working chamber 11 in the cylinder block. An intermediate space 12, whose function will be explained later, is formed between the two pistons in the area of their connection by the piston shaft S. The pressure intensifier piston preferably has a longitudinal axis situated parallel to the longitudinal axis L of the cylinder block 13.

It is easy to see that the transmission ratio, i.e. the factor by which the supplied low pressure can be increased, is dependent on the diameter ratio DN/DH of the low-pressure piston N and the high-pressure piston H.

In addition, a control piston 3 works in the cylinder block 13. Preferably, its longitudinal axis is also parallel to the longitudinal axis L of the cylinder block 13. Ideally, the control piston and the differential piston are disposed entirely or at least predominantly next to one another, viewed in a direction perpendicular to the longitudinal axis.

As can also be seen, all connecting pipes that are required for rendering the pressure intensifier functional are formed in the cylinder block 13. It must be noted that FIG. 1 shows the pressure intensifier piston 2, the control piston 3 and all connecting pipes required for operation projected in a plane, for the sake of a better overview. Preferably, i.e. in reality, the aforementioned components are not all situated in a single plane because such an arrangement would utilize the cross section of the cylinder block only extremely poorly: In the plane shown in the drawing of FIG. 1, the piston and the connecting pipes would crowd each other, whereas no piston and almost no connecting pipes would be found in a sectional plane perpendicular thereto that also contains the longitudinal axis.

Towards the outside, the pressure intensifier communicates with an external low-pressure source via its external low-pressure connection 5. From the former, the pressure intensifier receives lower-pressure hydraulic liquid that drives it. Preferably, a part of this hydraulic liquid that is fed into the pressure intensifier under lower pressure is put under higher pressure in the pressure intensifier and is discharged as a higher pressure hydraulic liquid to an external consumer by the pressure intensifier. Furthermore, the pressure intensifier has an external tank connection 6 via which it discharges to the outside at least a part of the hydraulic liquid received with a lower pressure if this hydraulic liquid has completed its work within the pressure intensifier. Discharge preferably takes place to an external tank or an external hydraulic liquid reservoir, but this is not obligatory. Furthermore, the pressure intensifier has another connection, the so-called external high-pressure connection 7. Through its high-pressure connection, the pressure intensifier discharges hydraulic liquid put under a higher pressure (compared to the supplied lower pressure) by it to a hydraulic work machine, such as rescue shears, a chucking means or a hydraulic collet chuck. Insofar as the term “external connection” is used herein, this means that a connection is external because the pressure intensifier can be directly connected to its surroundings via this connection. Internal connections are in contrast thereto, such as connecting channels via which the hydraulic functional components are connected with each other in the interior of the pressure intensifier.

As can be seen relatively well in FIG. 1, a low-pressure pipe 8 follows the external connection 5 to the low-pressure source within the cylinder block 13. The low-pressure pipe 8 soon branches out. It branches off into a low-pressure pipe section 8.1, which primarily serves for feeding fresh low-pressure fluid into the high-pressure working chamber, but also serves for supplying the control piston 3 with low pressure via the low-pressure pipe section 8.4. The preferably existing high-pressure working chamber 8.2 leads past the high-pressure working chamber directly into the pipe leading to the high-pressure consumer. If provided, the low-pressure pipe section 8.2 serves for first filling a newly connected, still empty high-pressure consumer with low-pressure fluid and to displace the air from the pipes of the high-pressure consumer, which may possibly still be empty at first, so that then, the high-pressure generation can be started.

A tank of return pipe 9 follows the connection 6 to the external tank. The tank or return pipe 9 soon branches out within the cylinder block 13, i.e. into a return pipe section 9.1 that comes from the control piston, and a pipe section 9.2 which, as will be discussed later, in due course and given a generally externally configured connection, serves as a control pipe for the controllable check valve 4.3.

Furthermore, a connecting pipe 14 from the control piston to the pressure intensifier piston is provided whose function will be explained in more detail later.

With regard to the control piston 3, it must be noted that this control piston 3 is also configured as a differential piston.

The basic mode of operation of the pressure intensifier can be explained rather clearly with reference to FIG. 1:

In the phase shown by FIG. 1, a work cycle is currently in progress, i.e. the pressure intensifier piston 2 moves in the direction of the black arrow into the high-pressure working chamber 11. At the beginning of the work cycle, the high-pressure working chamber 11 is first filled with low-pressure fluid, i.e. preferably with fluid under the low pressure of the feed pump. By moving the pressure intensifier piston into the high-pressure working chamber 11, the fluid located therein is put under increased pressure and discharged via the check valve 4.2 and the external high-pressure connection 7 to the high-pressure consumer.

The low-pressure working chamber 10, which continuously grows over the course of the work cycle, is constantly replenished with low-pressure fluid, i.e. with fluid obtained under the low pressure via the external low-pressure connection 5. This replenishment is carried out via the connecting pipe 14. The latter is connected by means of the control piston 3—i.e. via its narrowed area V1 positioned between the connections C and P—with the low-pressure pipe section 8.4, which carries low-pressure fluid.

In this case, the control piston 3 remains in the position shown by FIG. 1. At its one (in this case, the lower) end face, low pressure is constantly applied to it via the low-pressure pipe section 8.3. However, at the same time, low pressure is also applied to it via the control pipe 8.5 at its opposite (in this case the upper) end face since the start of the working cycle. This reason for this is that the high-pressure working chamber has been filled with low-pressure fluid at the start of the work cycle by means of the low-pressure pipe section 8.1. The low pressure in the control pipe 8.5 is maintained even if the high-pressure piston has moved across the mouth of the control pipe 8.5 in the high-pressure working chamber and thus sealed it. Due to the fact that the low pressure acts on a larger surface area at the upper end face of the control piston 3 than at the lower end face of the control piston, a downward resultant force permanently acts on the control piston 3.

It is important to note that the intermediate space 12 is also connected to the external tank connection 6, i.e. is kept pressureless. This is necessary in order to be able to drain off a possible leakage, which possibly flows from the high-pressure working chamber and/or the low-pressure working chamber into the intermediate space 12, so that no interfering counterpressure is able to form here, in this intermediate space, because hydraulic fluid is possibly confined therein.

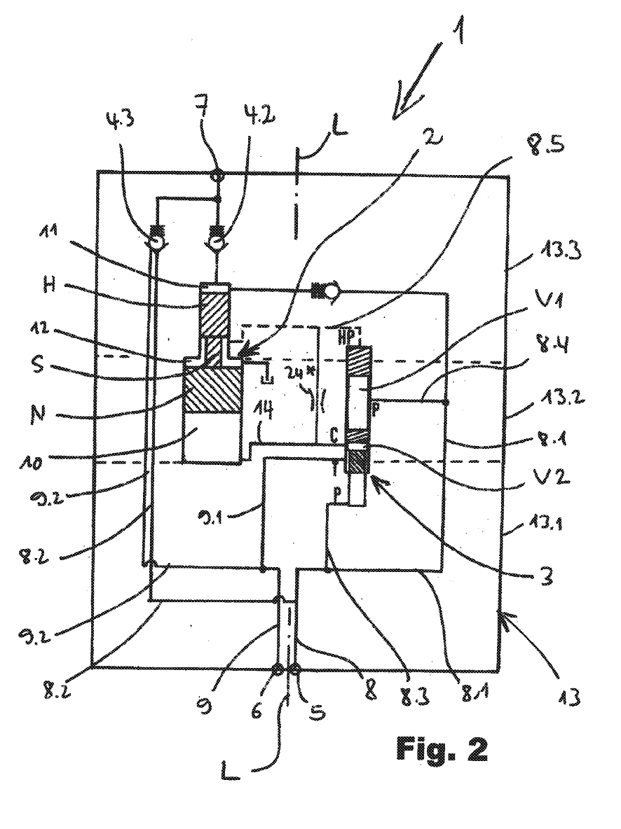

The work cycle continues until the pressure intensifier piston 2 has reached the position shown by FIG. 2, i.e. its upper dead center. As can be seen in FIG. 2, the high-pressure piston of the pressure intensifier piston has now entered the high-pressure working chamber 11 to such a depth that the edge thereof facing towards the intermediate space 12 has cleared the mouth of the control pipe 8.5 in the meantime, i.e. no longer moves across it and thus seals it. Thus, the mouth of the control pipe 8.5 is connected to the pressureless intermediate space 12, i.e. the pressure that has previously prevailed in the control pipe 8.5 during the work cycle collapses. Therefore, low pressure is now only applied to an end surface of the control piston, i.e. the lower end surface of the control piston 3 shown here in the illustration. Thus, the control piston 3 is pushed into its other position, i.e. conveyed from the position shown by FIG. 1 into the position shown by FIG. 2.

Due to said displacement of the control piston 3 into its second position, its narrowed area V1 is no longer hydraulically connected to the connecting pipe 14. Instead, the connecting pipe 14 is hydraulically connected with the return pipe section 9.1 via the second narrowed area V2 of the control piston 3. This results in the collapse of the low pressure in the low-pressure working chamber 10 because the low-pressure working chamber 10 is now switched to be pressureless. As a consequence, the forces that act on the upper end face of the high-pressure piston now prevail, which is why the pressure intensifier piston 2 now starts to move downwards and to displace the hydraulic fluid still located in the low-pressure working chamber 10 via the connecting pipe 14 and the return pipe section 9.1, so that it is discharged via the external tank connection 6.

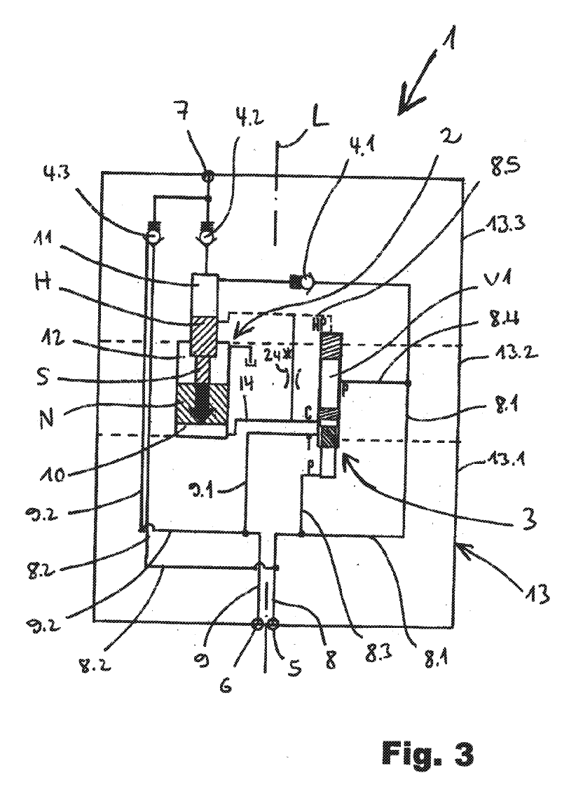

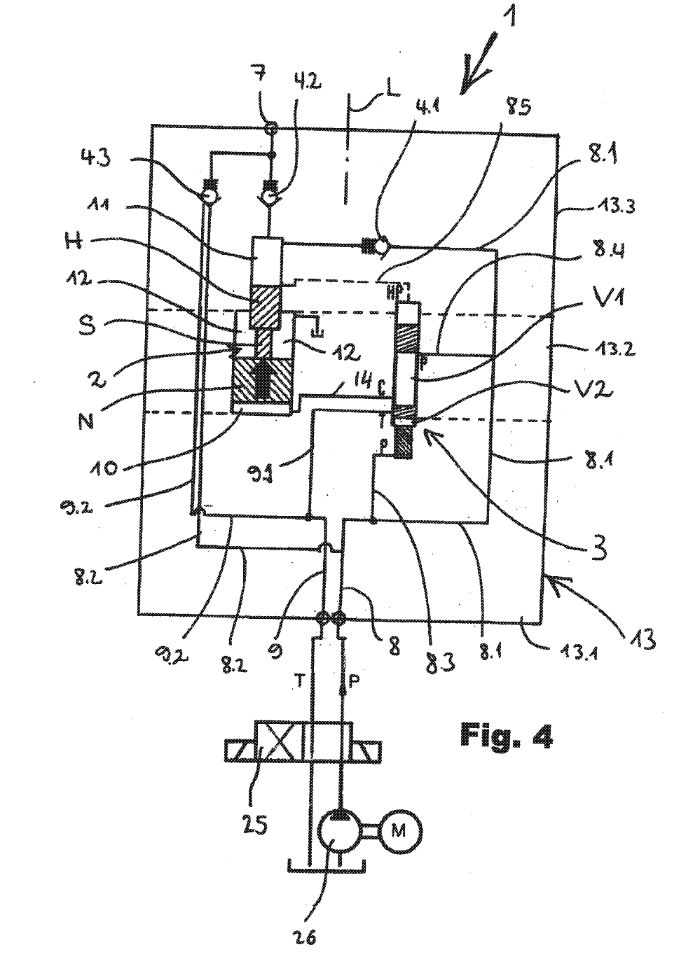

While FIG. 2 shows the upper dead center, i.e. the moment in which the pressure intensifier piston 2 has paused its movement and changes the direction of movement, FIG. 3 shows the charging cycle during which the low-pressure working chamber 2 again penetrates deeper into the low-pressure working chamber. The snapshot shown by FIG. 3 shows the pressure intensifier piston shortly before its lower dead center; at the moment, however, it still moves downwards.

FIG. 3 already gives an idea of what will happen shortly: It can be seen that the edge of the high-pressure piston facing towards the high-pressure working chamber 11 is about to connect the mouth of the control piston 8.5, which is still pressureless at the moment, with the currently low-pressure high-pressure working chamber 11. Once this has happened, the low pressure present at the moment in the high-pressure working chamber 11 spreads via the control pipe 8.5 and reaches the so far pressureless (upper) end face of the control piston 3. Once there is pressure present here, the control piston 3 is urged downwards, because the so far pressureless end face has a larger surface area than the other smaller end surface of the pressure intensifier piston, which is permanently under low pressure.

Once the control piston 3 has been urged back into its other position, its narrowed area V1 will again connect the connecting pipe 14 with the low-pressure pipe section 8.4 carrying low pressure, so that the pressure in the low-pressure pipe section 10 changes again. The low pressure of the low-pressure source is then again applied to the low-pressure working chamber 10, which is currently not under external pressure. At this moment, the pressure intensifier piston 2 reaches its lower dead center and pauses briefly. The charging cycle is at an end and a new work cycle, as it is shown by FIG. 1, starts.

It is to be noted that an advantage of the present disclosure is that the control piston works without a spring. The otherwise necessary application of a closing force of a spring is replaced with the constant application of the low pressure to an end face. This contributes to realizing the goal of building the pressure intensifier smaller because the constructional space required for accommodating a spring, which is to be incorporated in a replaceable manner and, to the extent possible, subsequently, is omitted.

It is easy to see in FIG. 4 what the reason is for the return pipe section 9.2 that leads from the tank or return pipe 9 to the controllable check valve 4.3.

This pipe serves for releasing the pressure on the high-pressure consumer in due time.

To do this, a pole reversal, so to speak, is carried out using a preferably externally disposed switching valve, i.e. the connection 5 that was so far connected to the external low pressure is now switched to be pressureless or connected to the tank via a valve that is preferably located externally, outside the cylinder block 13, and the connection 6 so far connected with the external tank is now connected to the low-pressure source. Because of this, low pressure can be routed via the return pipe section 9.2 to the control piston towards the control piston that opens the controllable check valve 4.3, so that the pipe to the high-pressure consumer that was so far blocked against the surroundings by the check valves 4.1 and 4.2 is able to discharge, via the now pressureless low-pressure pipe section 8.2, hydraulic liquid via the previous low-pressure pipe 8 and the now pressureless, previous low-pressure connection 5.

Now, it must be explained in more detail how the controllable check valve 4.3 works. The pressure intensifier according to the disclosure is operated with a preferably externally attached switching valve 25. In normal operation, the switching valve 25 is switched in such a way that the operation already described with reference to FIGS. 1 to 3 takes place, during which high-pressure fluid is generated; see FIG. 4.

In order to release the pressure on the high-pressure consumer, which is a regular requirement, for example, if it is a chucking means that is to release the workpiece clamped by is at the end of processing, the switching valve 25 is switched into the position as shown by FIG. 5. Basically, the only thing that happens is that the external connections 5 and 6 are “pole-reversed”. The connection 5, via which the externally generated low pressure was supplied so far, is now switched to be pressureless and thus corresponds to the tank or return connection. The external connection 6, which was so far operated as a tank of return connection, is now put under low pressure, e.g. via the external low-pressure feed pump 26, and thus becomes a low-pressure connection itself. As a consequence, the pipe section 9.2 is no longer pressureless, but now carries low pressure. This low pressure lifts the valve body of the controllable check valve 4.3 from its seat; it thus releases the check valve 4.3. Thereupon, the hydraulic fluid which was still stored in the high-pressure consumer until now drains off into the tank via the check valve 4.3 and the pipe 8.2. As a consequence, the pressure in the high-pressure consumer immediately collapses, of course, and the hydraulic system of the high-pressure consumer then empties itself into the tank, whereupon the high-pressure consumer can be uncoupled, which is very convenient if it is a rescue shears and the assignment is completed.

The pilot bore hole forming a throttle, which can be seen in FIGS. 1 to 4, is also worth noting. While the pilot bore hole is symbolized in the Figures in a exemplary-schematic way as a bypass throttle 24*, in reality, the pilot bore hole preferably penetrates the upper part of the control piston 3, which can be seen in the Figures, hatched towards the right-hand side. It connects the region of the upper end surface of the control piston 3 with the narrowed portion V1. In this way, the control pipe 8.5 is permanently connected to the narrowed portion V1. The purpose of this pilot bore hole is to ensure a defined position of the pressure intensifier piston 2 even if the pressure intensifier stood still for a long time. As long as the pilot bore hole is missing, the control pipe 8.5, after a longer downtime of the pressure intensifier piston, may have lost the pressure enclosed therein at first through micro-leaks and the control piston 3 may then assume an undefined position, which makes a new start-up difficult. The purpose of the pilot bore hole is to always ensure that the control pipe 8.5 is still properly pressurized even after a longer period of time, thus urging the control piston 3 into a defined position that enables a new start-up of the pressure booster without any problems. The flow via the pilot bore hole is selected to be so small as to be irrelevant during operation. The flow through the pilot bore hole builds up only in longer downtimes and thus shows the desired effect as it is described above.

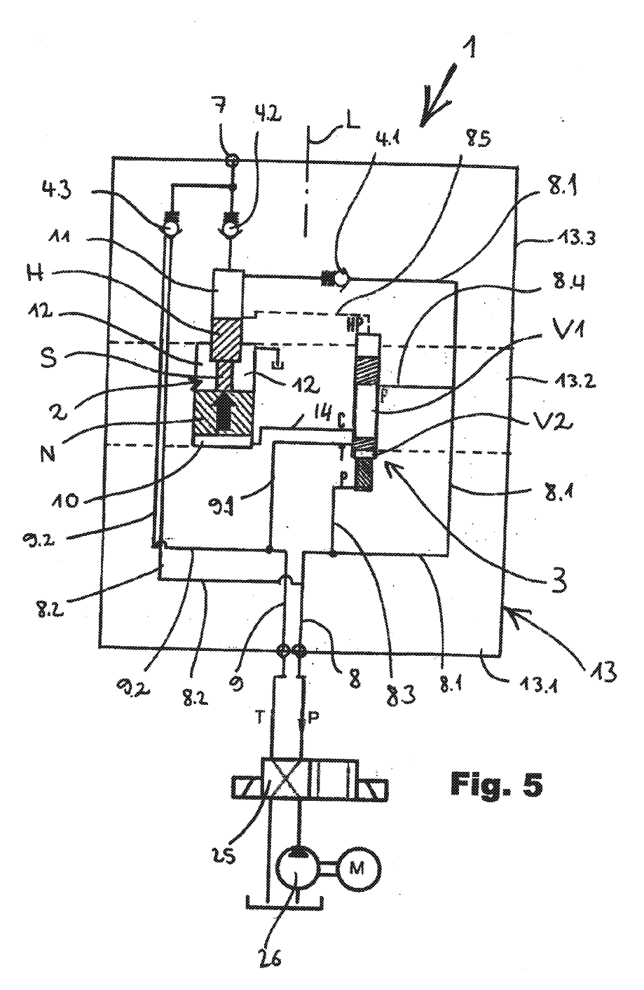

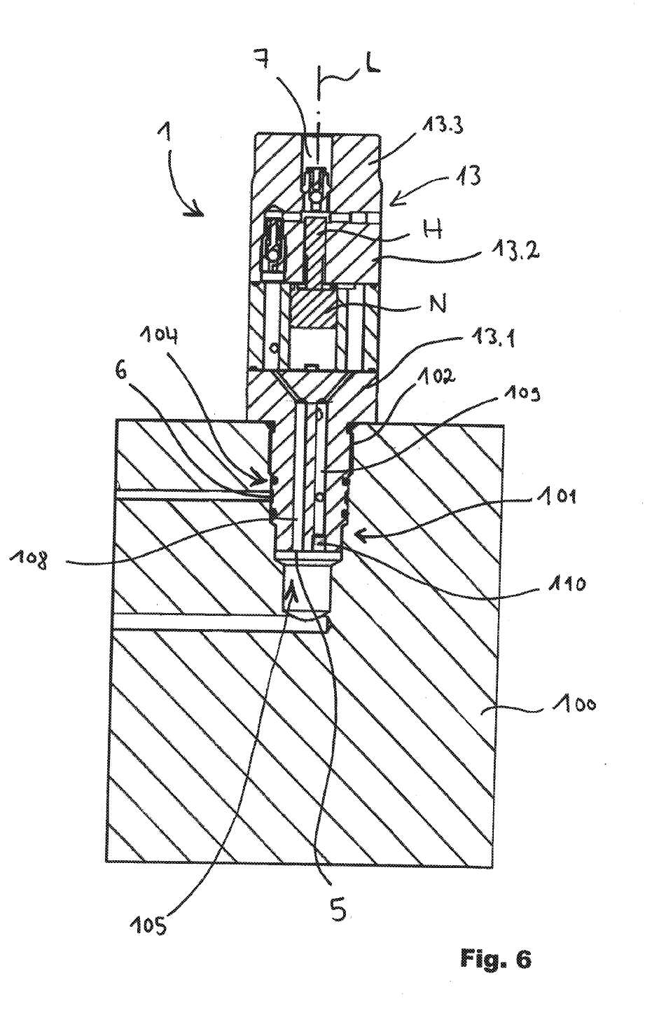

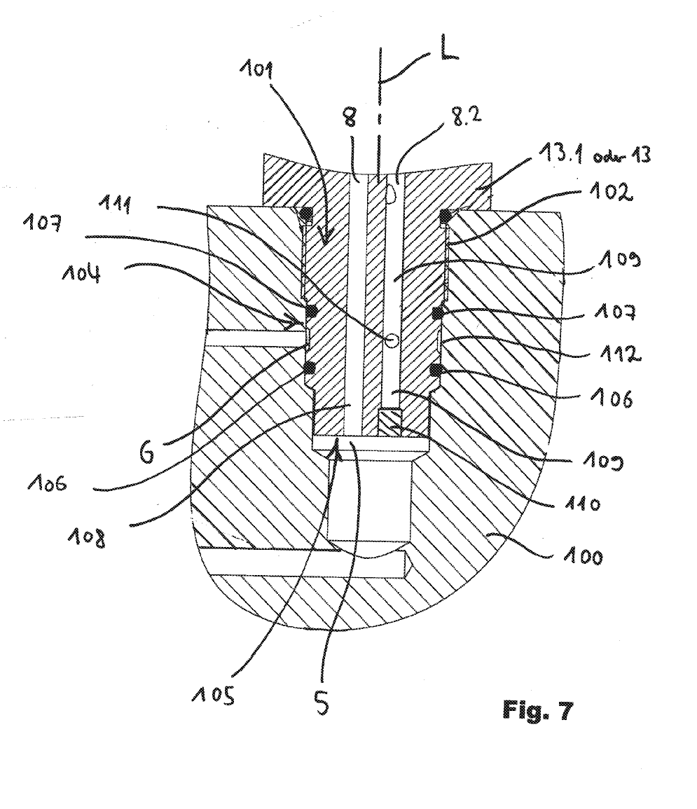

FIGS. 6 and 7 show a specific physical exemplary embodiment of a pressure intensifier according to the disclosure.

Here, FIG. 7 shows the coupling portion of the pressure intensifier according to FIG. 6 in an enlarged view.

FIG. 6 shows the pressure intensifier 1 according to the disclosure in its position mounted to an external hydraulic block 100. The hydraulic block is not a component of the pressure intensifier but constitutes, for example, the hydraulic control block of the chucking means. The hydraulic control block is in actual fact a massive metal control block (not a pipe joint or the like) in which a plurality of hydraulic channels is formed and which, for example, also comprises the actuator via which the user controls the installation hydraulically.

As can be seen, the cylinder block 13, or its cylinder block member 13.1, integrally merges into a coupling portion 101, i.e. a part of the circumferential shell surface of the cylinder block of the pressure intensifier forms the coupling portion 101.

The coupling portion 101 has a circular cylindrical shape. Preferably, it has a smaller diameter compared to the rest of the mostly also circular cylindrical cylinder block 13, ideally by at least 30%. The diameter of the coupling portion 101 preferably corresponds to the core diameter of a metric thread and is configured to be smaller than that by a dimensional tolerance that makes it possible to push the part of the coupling portion 101 that does not carry a male thread through the portion of the hydraulic block 100 carrying a female thread.

The length of the coupling portion 101 in the direction of the longitudinal axis L of the pressure intensifier 1 is preferably at least 25%, better at least 30% of the total length of the cylinder block 13 of the pressure intensifier 1. It is thus ensured that the coupling portion 101 is able to penetrate sufficiently deeply into the hydraulic block 100, into a region located in the solid material of the hydraulic block, underneath the mostly plane surface of the hydraulic block 100 which surrounds the bore for inserting the coupling portion 101.

Generally, the coupling portion 101, in its state of being incorporated into the hydraulic block 100, is surrounded all over its circumference by solid material of the hydraulic block (through which local channels may extend), which, seen in the radial direction, has a thickness that is larger by at least the factor 1.5 than the largest radius of the circular cylindrical cylinder block 13. Thus, the fluid transfer may take place where the hydraulic block 100 has a high strength or rigidity. In this connection, it has to be taken into consideration that the “low pressure” or lower pressure feeding the pressure intensifier does not at all have to be a low pressure in absolute terms. Where a very large differential pressure must be overcome, the pressure intensifiers according to the disclosure may be used in a cascading manner, i.e. a subsequent pressure intensifier is fed by the high pressure of the preceding pressure intensifier.

The coupling portion 101 not only ensures a fluidic connection between the pressure intensifier 1 and the hydraulic block 100 that the pressure intensifier supplies. Rather, it keeps the pressure intensifier 1 in its mounting position also mechanically by fully or predominantly absorbing the weight and all forces occurring in operation because of the mass of the pressure intensifier 1 and transferring them to the hydraulic block 100, e.g. the acceleration forces that arise on the pressure intensifier when the hydraulic block rotates or moves.

The coupling portion 101 is configured in such a way that it has been inserted into a bore of the hydraulic block 100 receiving it and fixed there.

For this purpose, the coupling portion 101 is preferably provided with a male thread 102 that is screwed into a corresponding mating thread of the bore in the hydraulic block 100 receiving the coupling portion 101.

As can be seen, the coupling portion 101 is configured in such a way that the bore of the hydraulic block 100 receiving it is able to enclose it completely on its circumference and its free end face.

As can best be seen in FIG. 7, two fluid transfer regions 104 and 105 are formed on the coupling portion 101. Seen in the direction of the longitudinal axis L of the pressure intensifier, they are located one behind the other and, seen in the screwing direction of the coupling portion, may be located in front of the region of the coupling portion provided with a male thread 102.

The first fluid transfer region 104 is preferably formed on the circumferential shell surface of the coupling portion 101. The second fluid transfer region may either also be formed on the circumferential shell surface of the coupling portion 101, or preferably at its free end surface.

Via these fluid transfer regions 104, 105 (and only through them), the pressure intensifier communicates directly towards the outside with the hydraulic block 100. These two fluid transfer regions are hydraulically separated from each other by a seal 106. The seal is preferably configured as a seal inserted with or without a supporting ring into a circumferential annular groove on the coupling portion. A further seal 107 is additionally provided—preferably in the same manner—which seals the fluid transfer region 104 located closer to the outside with respect to the outside.

The coupling portion 101 preferably has two bores 108 and 109 that extend mostly parallel to the longitudinal axis L. The latter extend from the free end face of the coupling portion 101 through the coupling portion into the region of the cylinder block 13 (or 13.1), which is located outside the hydraulic block 100, even if the pressure intensifier is mounted on the hydraulic block.

The one bore 108 transitions into the low-pressure pipe 8 shown by the FIGS. 1 to 5. This bore preferably leads into the free end face of the coupling portion and here constitutes the external low-pressure connection 5 (see FIG. 1) of the pressure intensifier.

That is located in the fluid transfer region 105 via which the pressure intensifier can be connected to the feed pipe carrying the low pressure, which here leads into the bottom of the bore of the hydraulic block 100 receiving the coupling portion 101. The fluid transfer region 105 is configured in such a way that a fluid-conducting connection between the pressure intensifier and the hydraulic block can be produced irrespective of the absolute screwing depth or the angle of rotation that the coupling portion has covered while being screwed into the hydraulic block.

The other bore 109 transitions into the tank or return pipe 9 shown by FIGS. 1 to 5. Where it actually leads into the free end face of the coupling portion 101, it is sealed by a plug 110. It is cut with a cross bore 111 leading into an annular groove 112. The annular groove 112 is located in said further fluid transfer region 105. Thus, the external tank connection 6 is formed.

Due to being equipped with the annular groove 112, the fluid transfer region 104 is also configured in such a way that a fluid-conducting connection between the pressure intensifier and the hydraulic block can be produced irrespective of the absolute screwing depth or the angle of rotation that the coupling portion 101 has covered while being screwed into the hydraulic block 100.

It must also be noted that the fluid transfer region 105 can alternatively be configured to correspond to the fluid transfer region 104, i.e. may be located on the circumferential shell surface of the coupling portion. However, such an embodiment is not preferred. It is particularly useful to provide the portion of the cylinder block 13 located outside the hydraulic block 100 with a coupling portion for a screwing tool, preferably in the shape of an external hexagon—which, however, is not shown in the drawings in this exemplary embodiment.

In this exemplary embodiment, the external high-pressure connection 7 is preferably located on the side of the pressure intensifier 1 facing away from the coupling portion 101. Here, a fluid-conducting connection to the high-pressure consumer is realized in a conventional manner.

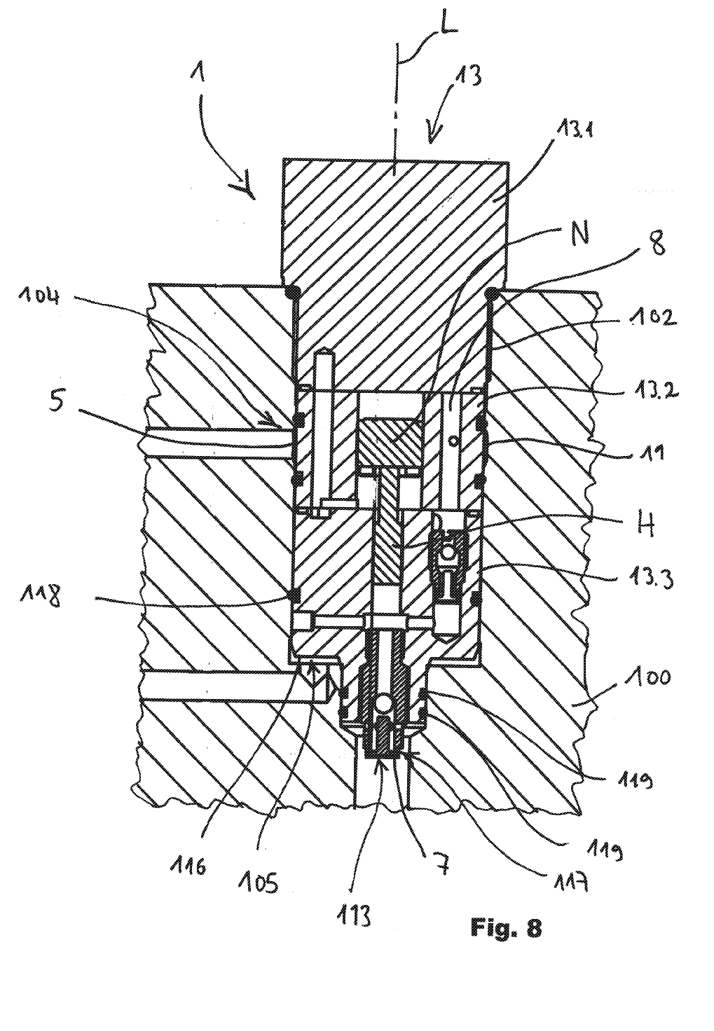

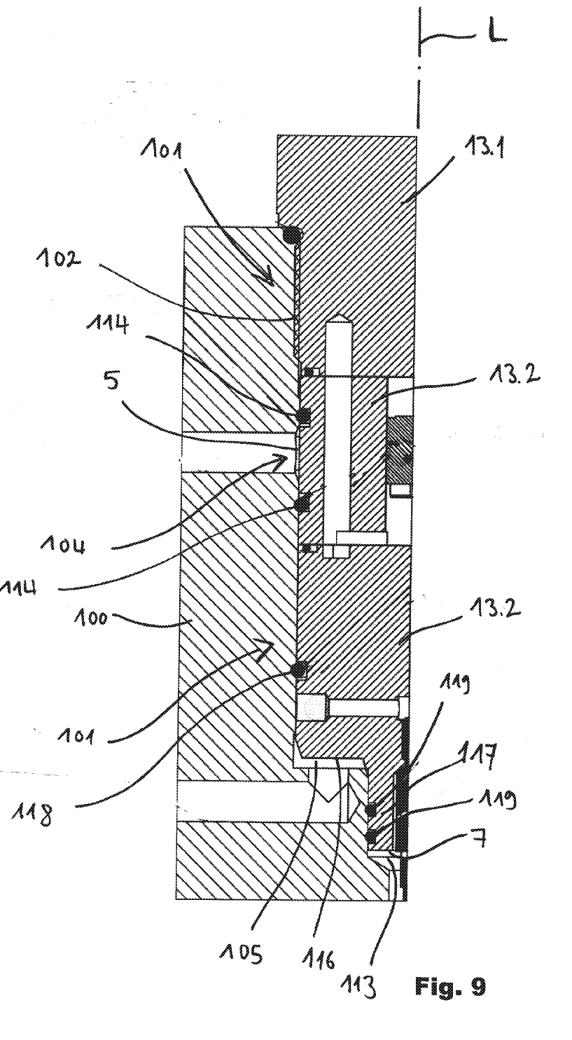

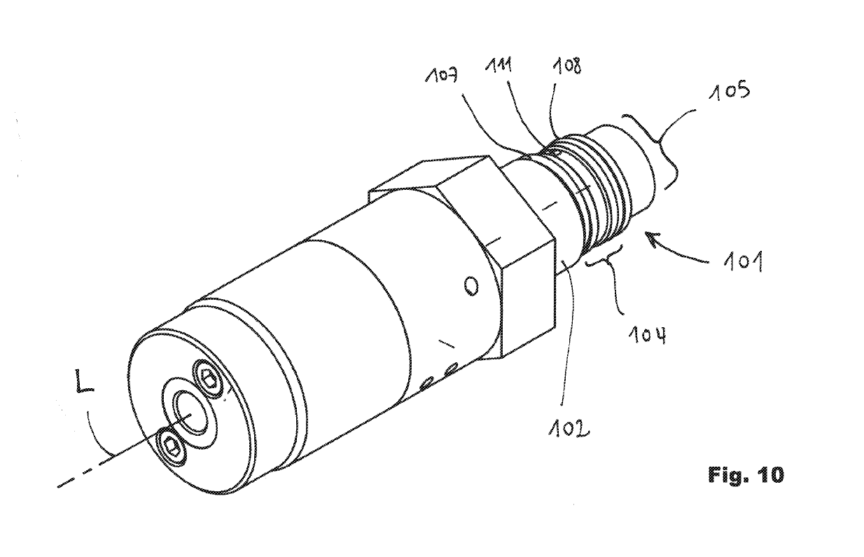

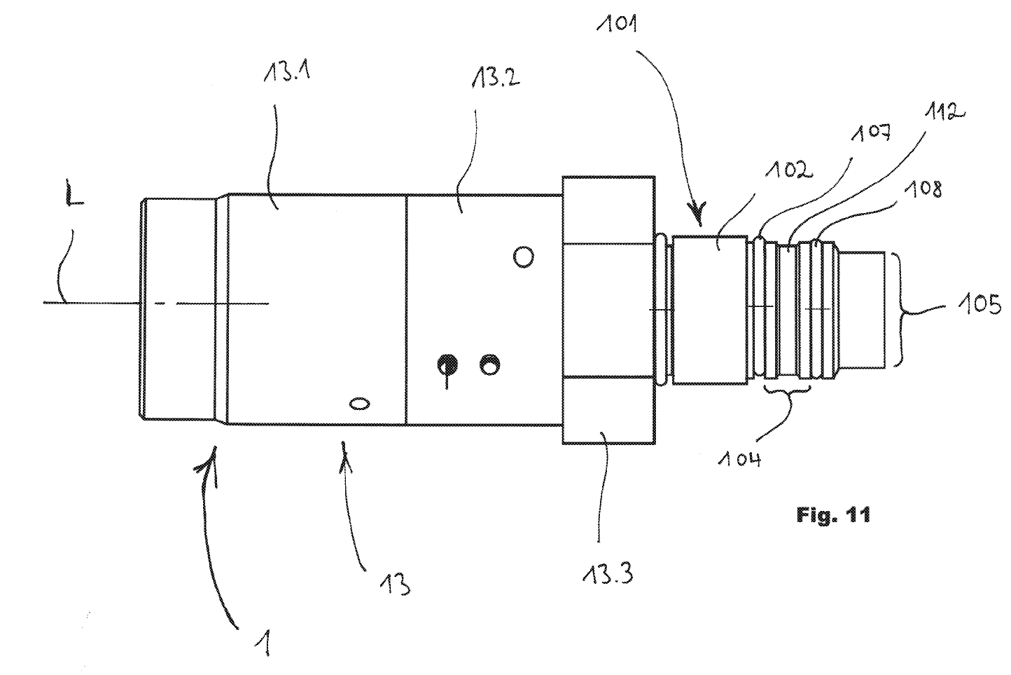

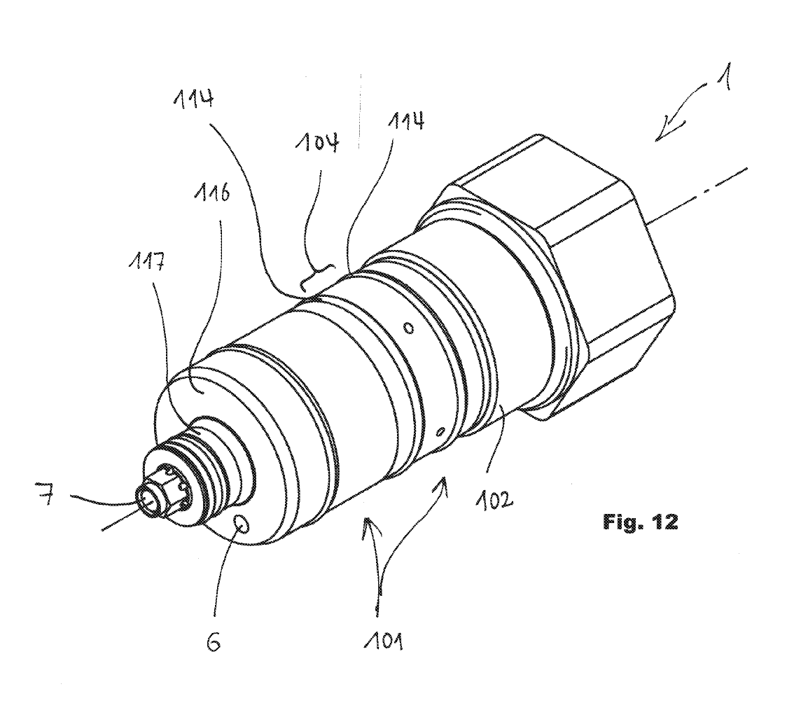

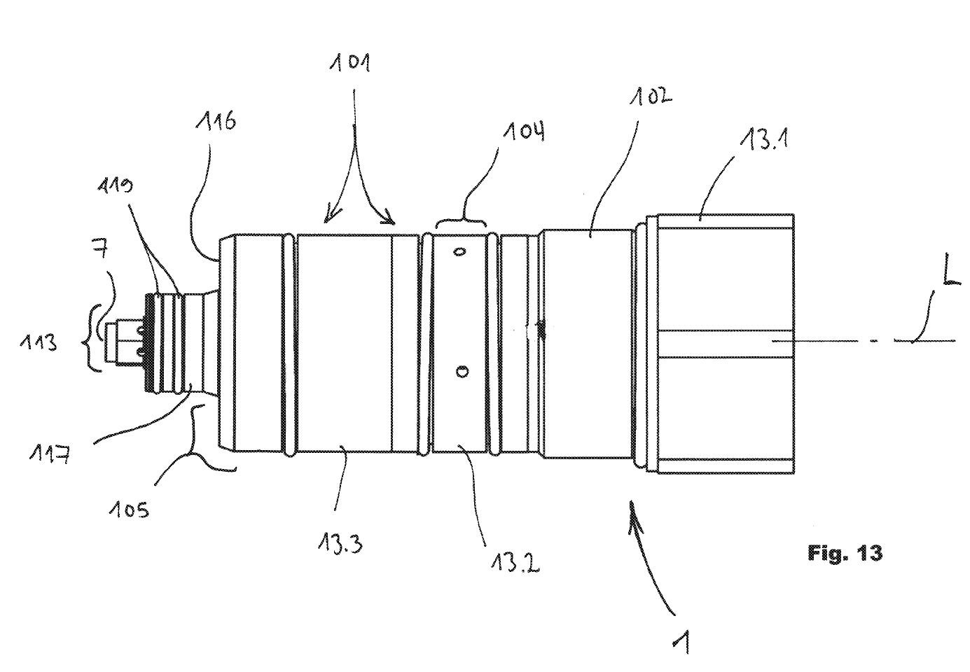

FIGS. 8 and 9 show a second specific exemplary embodiment of the pressure intensifier according to the disclosure. The above explanations for the first exemplary embodiment also apply here, unless otherwise described in the following. Here, the coupling portion is formed by the predominant part of the circumferential shell surface of the cylinder block 13.

Preferably, the cylinder block 13 of the pressure intensifier 1 is configured in such a way that it can be inserted into a bore of the hydraulic block 100 over at least ½, better ⅔ of the length that the cylinder block 13 has in the direction of its longitudinal axis L. In the specific case, the cylinder block is configured in such a way that the first and second cylinder block members 13.1 and 13.2 can be completely pushed into the hydraulic block 100. The highly stressed area of the pressure intensifier in which the differential piston moves back and forth is now entirely located in the hydraulic block, which thus provides a rigidity-increasing supporting effect.

As can be seen, the coupling portion 101 is configured in such a way, also in this case, that the bore of the hydraulic block 100 receiving it is able to enclose it completely on its circumference and its free end face.

Also in this case, it applies that the diameter of the coupling portion preferably corresponds to the core diameter of a metric thread and is configured to be smaller than that by a dimensional tolerance that makes it possible to push the part of the coupling portion that does not carry a male thread through the portion of the hydraulic block carrying a female thread.

In this exemplary embodiment, three fluid transfer regions 104, 105 and 113 are configured on the coupling portion 101. Seen in the direction of the longitudinal axis L of the pressure intensifier, they are located one behind the other and, seen in the screwing direction of the coupling portion, may be located in front of the region of the coupling portion provided with a male thread.

Via these fluid transfer regions 104, 105 and 113 (and only through them), the pressure intensifier 1 communicates directly with the outside, i.e. with the hydraulic block. An additional hose or tube connection for connection with the high-pressure consumer is not provided in this case; the high-pressure consumer is fed by the pressure intensifier 1 via the hydraulic block 100.

The first fluid transfer region 104 is delimited by seals 114 on both sides, which are preferably cord seals inserted with or without a supporting ring into a circumferential annular groove on the coupling portion 101.

The low-pressure pipe section 8, which can be seen well in FIG. 8, leads into a cross bore that leads on its other side into the outer surface of the cylinder block or (where provided) of the second cylinder block member 13.2, within the first fluid transfer region 104. The external low-pressure connection 5 is thus formed. Preferably, the cylinder block 13 does not have an annular groove in this region, for reasons of strength, but is smooth and therefore unweakened. Instead, the corresponding annular groove is in this case preferably mounted in the hydraulic block 100.

The “tank pipe” shown in FIG. 8 is preferably extended into the region of the end face step 116 of the coupling portion 101, where it opens into the second fluid transfer region 105, by a bore running within the cylinder block 13. Thus, the external tank connection 6 is formed. Preferably, the second fluid transfer region is delimited in the direction towards the outside of the hydraulic block by another seal 118 and thus kept small, wherein the seal is preferably also located in a peripheral annular groove of the coupling portion and may correspond to the seals 114, 115.

The end face step 116 is formed by the coupling portion tapering here.

The tapered cylinder appendage 117 of the coupling portion 101 is configured in such a way that it can be inserted into a second tapered part of the receiving bore, which is in this case configured as a stepped bore in the hydraulic block 100. The tapered cylinder appendage 117 carries at least one, better two, peripheral annular grooves, into which one or two seals 119 are inserted—most frequently with supporting rings. These one or two seals seal the third fluid transfer region 113 with respect to the second fluid transfer region 105. Thus, the third fluid transfer region is formed at the free end face of the coupling portion 101. The high-pressure pipe leads into the free end, so that the external high-pressure connection 7 is formed here.

Said tapering of the cylinder appendage 117 is realized taking into consideration the high pressure present there. Preferably, the latter makes it necessary to keep the distances to be sealed small, as well as the surfaces exposed to the high-pressure action, and thus to keep the forces arising there small.

Independent protection is also sought for a pressure intensifier cascade consisting of a hydraulic block 100 and several hydraulically series-connected pressure intensifiers 1, characterized in that the pressure intensifier 1, which are attached next to one another on the hydraulic block 100, are pressure intensifiers according to any one of the preceding claims.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure.

In general the terms and phrases used herein have their art-recognized meaning, which can be found by reference to standard texts, journal references and contexts known to those skilled in the art. The above definitions are provided to clarify their specific use in the context of the invention.

### LIST OF REFERENCE NUMERALS

1 Pressure intensifier
2 Pressure intensifier piston
3 Control piston
3.1 Control sleeve of control piston
3.2 Damping piston
4.1 Check valve
4.2 Check valve
4.3 Controllable check valve
5 Connection external low pressure (low-pressure connection)
6 Connection external tank (tank connection)
7 Connection external high-pressure consumer (high-pressure connection)
8 Low-pressure pipe
8.1 Low-pressure pipe section to the high-pressure working chamber
8.2 Low-pressure pipe section to the high-pressure consumer
8.3 Low-pressure pipe section for permanent biasing of the control piston
8.4 Low-pressure pipe section for enabling the control piston to transmit low-pressure working fluid
8.5 Control pipe
9 Tank or return pipe
9.1 Return pipe section to high-pressure consumer
9.2 Return pipe section to control piston
10 Low-pressure working chamber
11 High-pressure working chamber
12 Intermediate space
13 Cylinder block
13.1 First cylinder block member
13.2 Second cylinder block member
13.3 Third cylinder block member
14 Connecting pipe from control piston to pressure intensifier piston
15 to 24 not allocated
25 Switching valve
26 External low-pressure feed pump
27 to 99 not allocated
100 Hydraulic block
101 Coupling portion
102 Thread of coupling portion
103 Thread of coupling portion
104 First fluid transfer region
105 Second fluid transfer region
106 Seal
107 Seal
108 Bore
109 Bore
110 Plug
111 Cross bore
112 Annular groove
113 Third fluid transfer region
114 Seal
115 Seal
116 End face step
117 Cylinder appendage
118 Additional seal
119 Additional seal
L Longitudinal axis of the pressure intensifier or of its cylinder block
H High-pressure piston
N Low-pressure piston
S Piston shaft
DH Diameter high-pressure piston
DN Diameter low-pressure piston
V1 First narrowed area of the control piston
V2 Second narrowed area of the control piston
DW Wall thickness of the clamping sleeve
D Clear internal diameter of clamping sleeve

1. A pressure intensifier for liquids comprising:
a cylinder block in which a pressure intensifier piston and a control piston move cyclically, wherein the pressure intensifier piston forms a high-pressure working chamber and a low-pressure working chamber in the cylinder block and the cylinder block has a low-pressure connection for feeding in low-pressure fluid from outside;
a high-pressure connection for discharging higher-pressure working fluid towards the outside and a connection for discharging fluid whose working capacity in the pressure intensifier is exhausted;
the cylinder block having a coupling portion rigidly connected with said cylinder block, said coupling portion can be inserted into a receiving bore of a hydraulic block and fixed there, so that the receiving bore encloses the coupling portion, wherein the coupling portion has at least two fluid transfer regions fluidically separated by a seal, for exchanging fluid between the pressure intensifier and the hydraulic block into which it is inserted.

2. The pressure intensifier of claim 1, wherein coming from inside the cylinder block a channel, via which the pressure intensifier discharges fluid in operation whose working capacity is exhausted, leads into a fluid transfer region and that a further channel, via which low-pressure fluid is fed into the pressure intensifier leads into another fluid transfer region.

3. The pressure intensifier of claim 1 wherein the coupling portion has a third fluid transfer region for transferring the higher-pressure working fluid to the hydraulic block.

4. The pressure intensifier of claim 1 wherein at least one of the fluid transfer regions comprises a peripheral annular groove.

5. The pressure intensifier of claim 1 wherein at least one channel leads into the end face (entire end or end surface of an annular shoulder) of the coupling portion ideally the channel via which the higher-pressure working fluid is discharged by the pressure intensifier.

6. The pressure intensifier of claim 1 wherein the coupling portion has a thread for screwing the coupling portion into a hydraulic block.

7. The pressure intensifier of claim 7 wherein the fluid transfer regions (are disposed between the free end of the coupling portion (100) to be inserted into the hydraulic block (100) and the thread (102) of the coupling portion.

8. The pressure intensifier of claim 1 wherein the cylinder block of the pressure intensifier has a molded-on hexagon.

9. The pressure intensifier of claim 1 wherein at least two bores extending parallel to the longitudinal axis (L) of the pressure intensifier run through coupling portion, which extend from the free end face of the coupling portion into the area of the cylinder block, which is always positioned outside the hydraulic block accommodating the coupling portion.

10. The pressure intensifier (1) according to claim 9, wherein the end leading into the free end face of the coupling portion is sealed by a plug at least one of the bores, and that this bore intersects a cross bore that leads into a fluid transfer region.

11. A hydraulic unit comprising a hydraulic block in which several bores, through which hydraulic fluid flows, for connecting different hydraulic operative units are formed, and at least one pressure intensifier of claim 1 wherein the pressure intensifier has a coupling portion inserted into a bore in the hydraulic block.

12. The hydraulic unit according to claim 11, wherein the hydraulic unit comprises several pressure intensifiers each of which has a coupling portion inserted into a bore of the hydraulic block.

13. The hydraulic unit according to claim 12, wherein at least two, better at least three, pressure intensifiers are connected in series one behind the other, so that the high pressure provided by a pressure intensifier preceding in the flow direction constitutes the pressure with which a subsequent pressure intensifier in the flow direction is supplied on the input side.
